(19) United States
(12) Patent Application Publication
(10) Pub. No.: US 2017/0141591 A1
(43) Pub. Date: May 18, 2017

(54) BALANCED BATTERY CHARGING DEVICE

(71) Applicant: ZONESKING TECHNOLOGY CO., LTD., NEW TAIPEI CITY (TW)

(72) Inventors: LI-BANG CHEN, NEW TAIPEI CITY (TW); TZU-YU YANG, NEW TAIPEI CITY (TW); JIA-YI WU, NEW TAIPEI CITY (TW)

(21) Appl. No.: 14/944,177

(22) Filed: Nov. 17, 2015

(51) Int. Cl. H02J 7/00

(52) U.S. Cl. CPC H02J 7/0026; H02J 7/0021; H02J 7/0083; H02J 7/0085

(57) ABSTRACT

The battery charging device contains at least a first charging battery, at least a second charging battery, and a control module parallel-connected to the first and second charging batteries. The control module contains a control unit, a detection element, and a switch element. The control unit is configured with a current threshold. The detection element detects a total current from the first and second charging batteries. The control unit triggers the switch element to disconnect the first charging battery when the total current is greater than the current threshold. The control unit then triggers the switch element to reconnect the first charging battery when the total current drops below the current threshold.

### BACKGROUND OF THE INVENTION

(a) Technical Field of the Invention

The present invention is generally related to batteries, and more particular to a battery charging device.

(b) Description of the Prior Art

To prepare for a vehicle's battery running out of electricity, there are emergency battery charging devices to jump start the vehicle.

Existing battery charging devices usually involve two batteries parallel-connected together. However there are a number of disadvantages.

For the two parallel-connected batteries, one with higher voltage will charge the other one with lower voltage, and the magnitude of the charging current is proportional to their voltage difference. When the charging current is too high and exceeds the rated current of the cable connecting the batteries, the cable would be heated up, short circuited, or even the batteries would be burned or exploded. Similarly, if the charging current exceeds the rated current of the charged battery, the charged battery would suffer speeded up aging, and shorten operational life. Under serious condition, the charged battery could even be heated up, deformed, burned, or exploded, causing significant property damage and loss of lives.

### SUMMARY OF THE INVENTION

The present invention therefore provides a novel battery charging device that contains at least a first charging battery, at least a second charging battery, and a control module parallel-connected to the first and second charging batteries. The control module contains a control unit, a detection element, and a switch element. The control unit is configured with a current threshold. The detection element detects a total current from the first and second charging batteries. The control unit triggers the switch element to disconnect the first charging battery when the total current is greater than the current threshold. The control unit then triggers the switch element to reconnect the first charging battery when the total current drops below the current threshold.

A major objective of the present invention is to protect the first and second charging batteries and to prolong their operational lives by setting the current threshold of the control unit below their rated currents.

In addition, by the detection element's detecting and the switch element's periodical on/off, two-way, balanced charging under limited current is achieved. In other words, the first and second charging batteries charge each other (i.e., two-way) and the detection and switch elements jointly provide limitation and balance.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram showing a battery charging device according to an embodiment of the present invention.

FIG. 2 is a perspective diagram showing the battery charging device of FIG. 1.

FIG. 3 is functional block diagram showing the battery charging device of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims

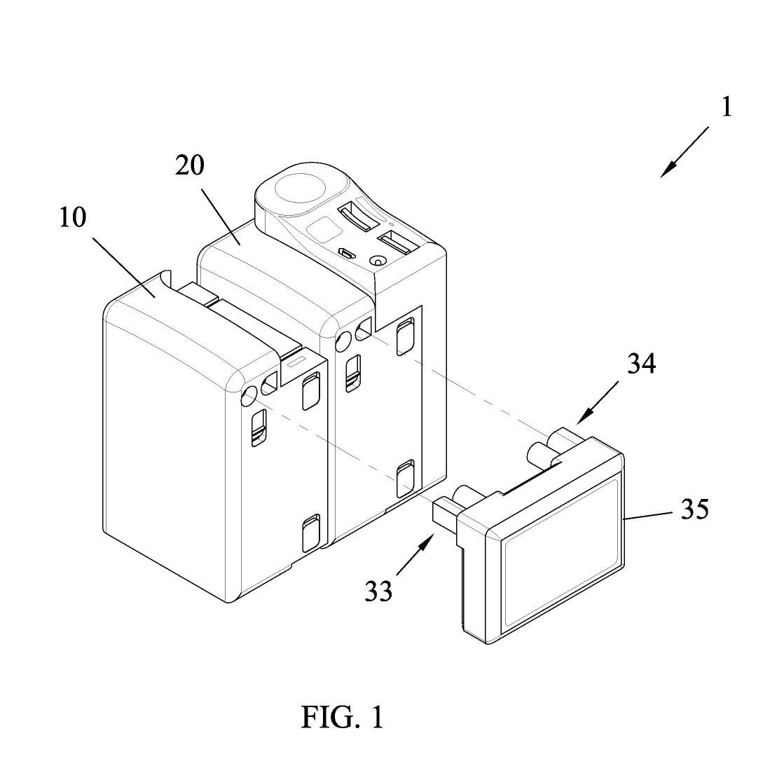

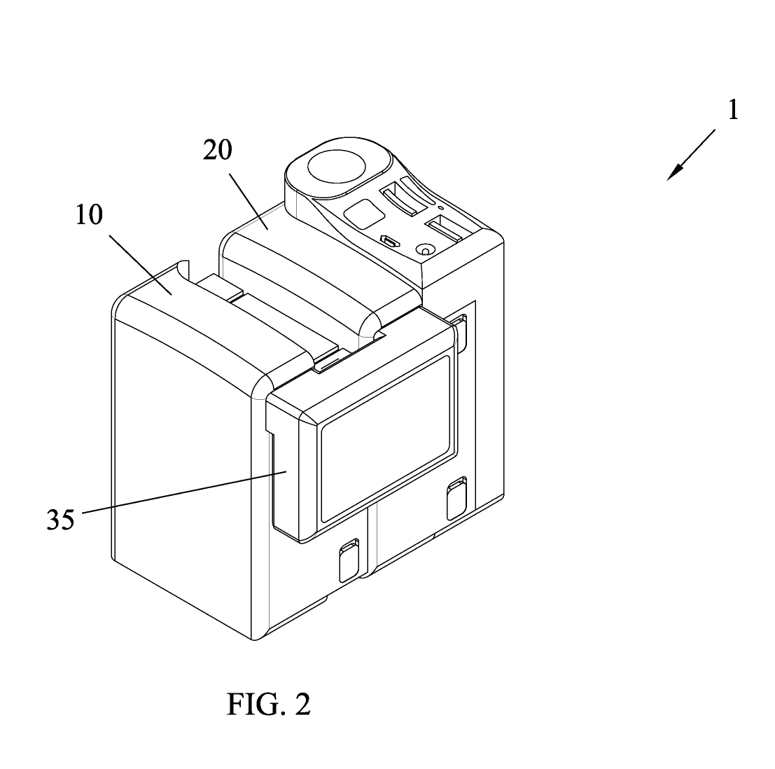

As shown in FIGS. 1 and 2, a battery charging device 1 according to an embodiment of the present invention contains at least a first charging battery 10, at least a second charging battery 20, and a control module.

As shown in FIGS. 1 to 3, the control module is parallel-connected to the first and second charging batteries 10 and 20. The control module is housed in a case 35 and contains a detection element 31, a switch element 32, a control unit 30, a first input port 33, and a second input port 34. The control unit 30 mainly contains a processing element which can be a MCU, OP, or a comparator. The switch element is a MOS switch.

The first and second input ports 33 and 34 are extended outside the case 35 for connection with the first and second charging batteries 10 and 20, respectively, thereby achieving the parallel connection.

The control module may further contains a functional unit 40 connected to the control unit 30, which contains at least a lighting element, a display, and at least an audio unit (all omitted from the drawings).

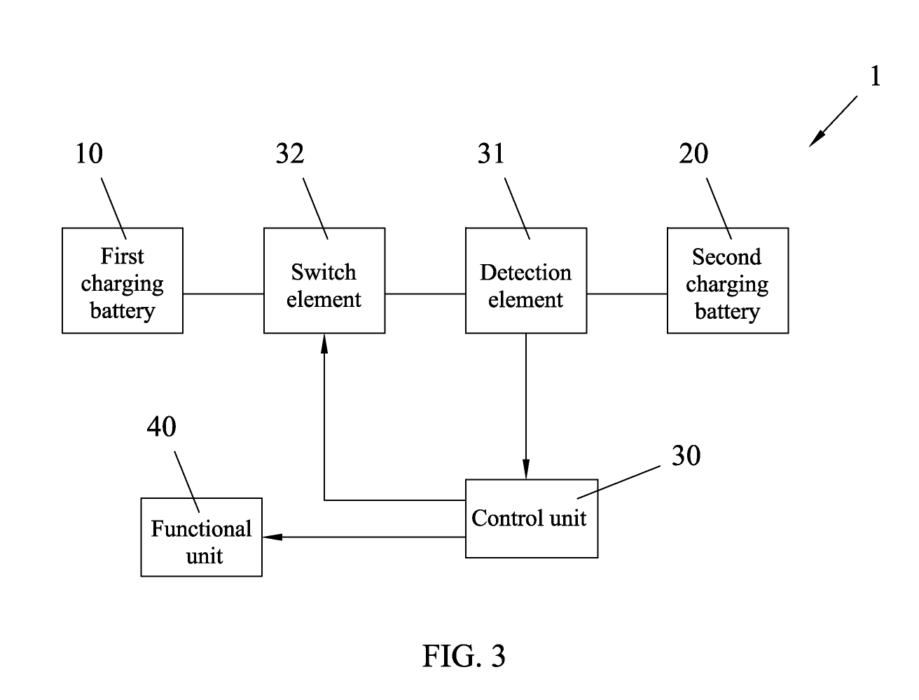

As shown in FIGS. 2 and 3, the control unit 30 is configured with a current threshold. The detection element 31 detects a total current out of the first and second charging batteries 10 and 20 and delivers a corresponding signal to the control unit 30. Determining that the total current is greater than the current threshold, the control unit 30 triggers the switch element 32 to disconnect the first charging battery 10 so that only the second charging battery 20 alone provides output current.

Then, when the current output from the second charging battery 20 drops below the current threshold, the control unit 30 triggers the switch element 32 to reconnect the first charging battery 10. The foregoing process is then continuously repeated so that the first charging battery 10 periodically joins to provide the output current, and that the first and second charging batteries 10 and 20 charge each other. Please note that the current threshold is less than or equal to the rated currents of the first and second charging batteries 10 and 20 so as to protect the first and second charging batteries 10 and 20 and to prolong their operational lives.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A battery charging device, comprising:
at least a first charging battery;
at least a second charging battery; and
a control module parallel-connected to the first and second charging batteries;
wherein the control module comprises a control unit, a detection element, and a switch element; the control unit is configured with a current threshold; the detection element detects a total current from the first and second charging batteries; the control unit triggers the switch element to disconnect the first charging battery when the total current is greater than the current threshold; and the control unit triggers the switch element to reconnect the first charging battery when the total current drops below the current threshold.

2. The battery charging device according to claim 1, wherein the control module further comprises a first input port and a second input port for connection with the first and second charging batteries, respectively; and the current threshold is less than or equal to the rated currents of the first and second charging batteries.

3. The battery charging device according to claim 1, wherein the control module further comprises a functional unit; and the functional unit comprises one of a lighting element, a display, and an audio unit.

4. The battery charging device according to claim 3, wherein the control unit comprises a processing element which is one of a MCU, an OP, and a comparator.

5. The battery charging device according to claim 1, wherein the switch element is a MOS switch.

6. The battery charging device according to claim 2, wherein the control module further comprises a functional unit; and the functional unit comprises one of a lighting element, a display, and an audio unit.
